(19) United States
(12) Patent Application Publication
(10) Pub. No.: US 2010/0304756 A1
(43) Pub. Date: Dec. 2, 2010

(54) METHOD AND APPARATUS FOR DISCOVERING SIGNIFICANT PLACES

(75) Inventor: Guang YANG, San Jose, CA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/476,503

(22) Filed: Jun. 2, 2009

(51) Int. Cl. H04W 64/00; H04M 1/00

(52) U.S. Cl. 455/456.1; 455/566

(57) ABSTRACT

An approach is provided for determining significant places from cell identifiers. A circular sequence of cell identifiers associated with a mobile device is determined. Each of the cell identifiers has timing information according to when the mobile device has coverage by a corresponding one of a plurality of cells. The circular sequence also has a predetermined cardinality. The cell identifiers of the circular sequence are correlated using the timing information. One or more clusters of cell identifiers are generated based on the correlated cell identifiers. The one or more clusters are designated as one or more significant places.

### BACKGROUND

Service providers and device manufacturers (e.g., cellular phones) are continually challenged to deliver value and convenience to consumers by, for example, providing compelling network services, applications, and content as well as user-friendly devices. Important differentiators in this industry are application and network services. In particular, location-based services are becoming more readily available to users, and have largely being based on global positioning system (GPS) technology. However, such GPS technology are only deployed on higher end cellular devices, due to cost. Consequently, the location-based services are confined to these devices, which constitute a narrow part of the mobile device market.

### SOME EXAMPLE EMBODIMENTS

Therefore, there is a need for an approach for providing location-based services using existing network infrastructure.

According to one embodiment, a method comprises determining a circular sequence of cell identifiers associated a mobile device. Each of the cell identifiers has timing information according to when the mobile device has coverage by a corresponding one of a plurality of cells. The circular sequence has a predetermined cardinality. The method also comprises correlating the cell identifiers of the circular sequence using the timing information. The method further comprises generating one or more clusters of cell identifiers based on the correlated cell identifiers. The one or more clusters are designated as one or more significant places.

According to another embodiment, an apparatus comprising at least one processor, and at least one memory including computer program code, the at least one memory and the computer program code configured to, with the at least one processor, cause the apparatus to determine a circular sequence of cell identifiers associated a mobile device. Each of the cell identifiers has timing information according to when the mobile device has coverage by a corresponding one of a plurality of cells. The circular sequence has a predetermined cardinality. The apparatus is also caused to correlate the cell identifiers of the circular sequence using the timing information. The apparatus is further caused to generate one or more clusters of cell identifiers based on the correlated cell identifiers. The one or more clusters are designated as one or more significant places.

According to another embodiment, a computer-readable storage medium carrying one or more sequences of one or more instructions which, when executed by one or more processors, cause an apparatus to determine a circular sequence of cell identifiers associated a mobile device. Each of the cell identifiers has timing information according to when the mobile device has coverage by a corresponding one of a plurality of cells. The circular sequence has a predetermined cardinality. The apparatus is also caused to correlate the cell identifiers of the circular sequence using the timing information. The apparatus is further caused to generate one or more clusters of cell identifiers based on the correlated cell identifiers. The one or more clusters are designated as one or more significant places.

According to another embodiment, an apparatus comprises means for determining a circular sequence of cell identifiers associated a mobile device. Each of the cell identifiers has timing information according to when the mobile device has coverage by a corresponding one of a plurality of cells. The circular sequence has a predetermined cardinality. The apparatus also comprises means for correlating the cell identifiers of the circular sequence using the timing information. The apparatus further comprises means for generating one or more clusters of cell identifiers based on the correlated cell identifiers. The one or more clusters are designated as one or more significant places.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of discovering significant places using cell identifiers, according to one embodiment;

FIG. 2 is a diagram of the components of a user equipment, according to one embodiment;

FIG. 3 is a flowchart of a process for discovering significant places using cell identifiers, according to one embodiment;

FIGS. 4A and 4B are flowcharts of processes for discovering significant places using cell identifiers, according to one embodiment;

FIG. 5 is a diagram of coverage areas of cell sites, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF PREFERRED EMBODIMENT

A method, apparatus, and software for discovering significant places using cellular identifiers are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to cellular identifiers in the context of a cellular network, it is contemplated that the approach described herein may be used with other radio communication technologies and unique identifiers of access points.

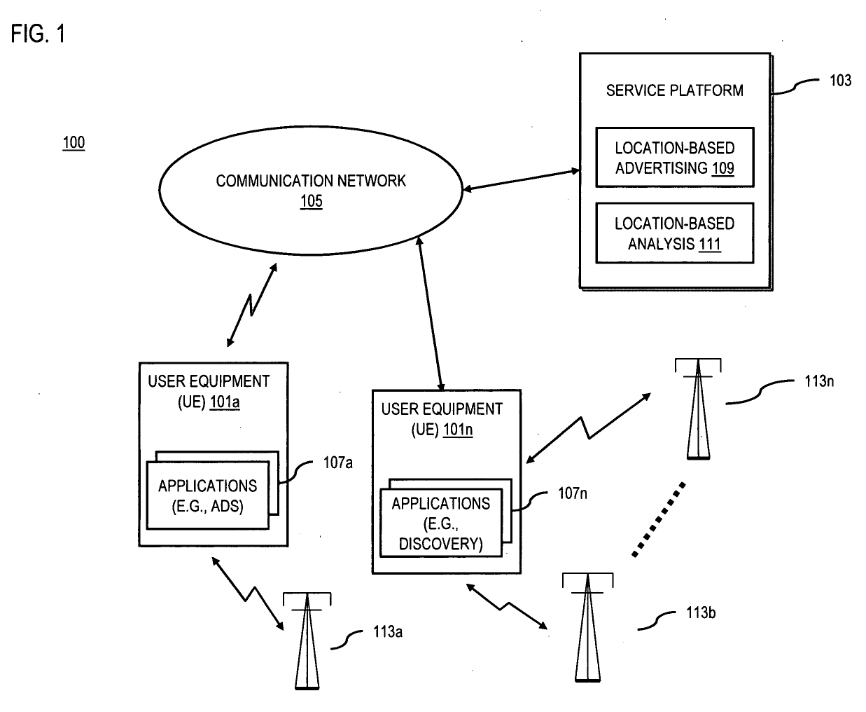

FIG. 1 is a diagram of a system capable of discovering significant places using cell identifiers, according to one embodiment. Under the scenario of FIG. 1, a system 100 involves user equipment (UE) 101 having connectivity to a service platform 103 over a communication network 105. The service platform 103 provide location-based services to the UEs 101, according to one embodiment, with the need of global positioning system (GPS) technology. In a mobile world, increasing services and applications are being offered to users based on locations. Many services attempt to utilize a user's physical location for advertising, social network services, and other location-based services. Determining the location of a user can be difficult. For example, GPS requires a clear view of the sky to determine a location and has poor reception in an obstructed environment. Additionally, GPS consumes a large amount of energy if used continuously or suffers prolonged lock-on latency periods if used on demand. Also, due to GPS's manufacturing costs, it is generally only available in more expensive middle to high-end phones.

Generally, mobile devices rely on cellular network infrastructure for communications. A mobile device identifies a cell and connects to the cell during operation. Most mobile devices know the cell identification (cell-ID) of the coverage area (or cell) the mobile device connects to. Thus, it would be efficient to discover significant places using a cell-ID system because cell-ID systems are almost universally available; and there is little cost in regards to manufacturing costs and energy consumption of implementing a cell-ID localization system. Mobile devices are created to utilize a cell, and thus have the hardware built-in for such capability. The cell-ID of the tower connected to the mobile device is known, thus there is little additional energy cost in implementing a system using that information. However, cell-ID systems yield coarse accuracy with respect to location and cannot easily provide cell-ID-to-physical-location mapping. Such mapping is difficult because a cell may span large distances (e.g. well over several square kilometres), and because mobile carriers (e.g., cell tower owners) do not freely provide cell tower locations. Additionally, it is difficult for a mobile device to receive cell data of a cell that the mobile device is not connected to. Thus, an approach is needed to determine significant places based on available cell data.

To address this problem, system 100 introduces the capability to discover significant places using cell identifiers. According to one embodiment, this can be performed on the user equipment (UE) 101. An approach can be used to determine significant places based on a sequence of cell-IDs and timestamps of when the sequence data was collected. As used herein, the term significant place is a location, such as a point of interest (POI), geo-coordinates, address, etc., in which the user equipment is deemed to have visited; statistically, this location can be recurring or non-recurring. It is noted that “significant” or “important” can be defined objectively (e.g., by a service provider) or subjectively by the user.

In one embodiment, UE 101 can be used by a user to communicate with a service platform 103 that provides location-based services via a communication network 105. The UE 101 may use an application 107a-107n, such as an advertisement application 107a, that provides different features depending on the location of the UE 101. These applications may utilize the services of the service platform 103, such as a location-based advertising service 109 or a location-based analysis service 111. Additionally, a UE 101 can include a discovery application 107n that can help support the location-based services of the service platform 103. In one embodiment, the discovery application 107n on the UE 101 can determine a user's significant places solely from observed cell-IDs.

In one embodiment, a cell-ID can be obtained from a cell site 113a-113n. A cell site 113 (e.g., a base station, a cellular repeater, etc.) can include a tower or other elevated structure for mounting antennas, and one or more sets of transmitters, receivers, transceivers, digital signal processors, control logic, global positioning receivers, or a combination thereof. Because the discovery application 107n can discover a user's important locations based on cell-IDs, it is not required to map the cell-ID to a physical location or obtain multiple cell-IDs simultaneously. This can be accomplished using a cell-ID clustering algorithm based on temporal correlations. According to one embodiment, analysis can be executed on the UE 101 without data connectivity or on a service platform 103 obtaining input data from the UE 101. Using this approach, a discovery application 107n can discover places of importance to a user (e.g., home or work) as well as less frequently recurring places and one-time travel destinations that bear some significance in a user's life (e.g., a vacation location, work trip, etc.) based on patterns. For example, a significant location where a user spends a long period of the night on a regular basis may be analyzed as a home location. In one embodiment, once a cell cluster is determined to be a significant location, a user can be queried to input an identifier to the location. For example, a discovery application 107n can ask the user where the user was between 1 μm and 5 μm. This time frame can correspond to the time period a specific cluster was observed. The user can then input the location (e.g., home, work, vacation location, etc.).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101 and service platform 103 can communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

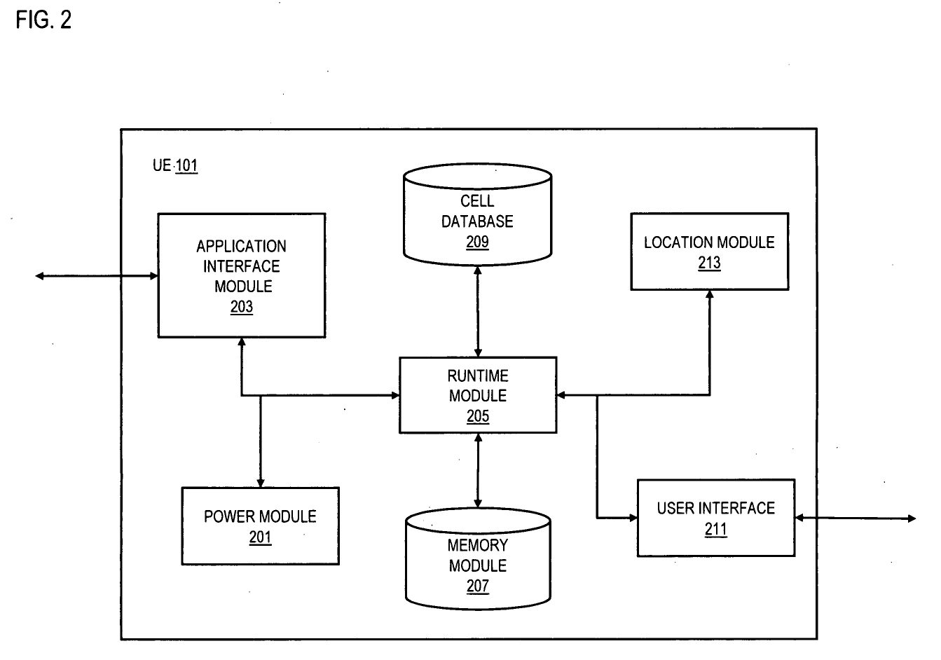

FIG. 2 is a diagram of the components of a user equipment 101, according to one embodiment. By way of example, the UE 101 includes one or more components for discovering important locations. It is contemplated that the functions of these components may be combined in one or more components or performed by other components of equivalent functionality. In this embodiment, the UE 101 includes a power module 201, an application interface module 203, a runtime module 205, a memory module 207, a cell database 209, a user interface 211, and a location module 213.

The power module 201 provides power to the UE 101. The power module 201 can include any type of power source (e.g., battery, plug-in, etc.). Additionally, the power module can provide power to the components of the UE 101 including processors, memory, and transmitters.

In one embodiment, the UE 101 includes an application interface module 203. The application interface module 203 is used by a runtime module 205 to request and receive services from the service platform 103. These services can utilize discovered user locations (e.g., home, work, business trip, etc). The application interface module 203 can use multiple communications technologies to communicate with a service platform 103. For example, the application interface module 203 can interface with the service platform 103 using a wireless local area network (WLAN), or a cellular network.

In one embodiment, the UE 101 includes a location module 213. The runtime module 205 can use the location module 213 to discover a user's location. A UE 101 with access to a cellular network can determine the cell site 113 that the UE 101 is connected to by obtaining a cell-ID. A raw cell-ID can contain a unique identifier to the cell, a network code (e.g., a cellular service provider's identifier), an area identifier (e.g., area code), and a country code. A cell-ID and a timestamp can be stored in a cell database 209. Additionally, the location module 213 can collect time zone information and signal strength information. The runtime module 205 can process the cell-ID data (or send the data to a service platform 103 to process) via a clustering algorithm to discover a user's locations. The clustering algorithm can have parameters to handle missing data as well as prevent over-clustering (e.g., clustering two locations into a single location when the two locations are not the same). The runtime module 205 can then store any discovered locations in the cell database 209. The cell database 209 can then be accessed to determine if the current location is a discovered location. An application 107 or a service platform 103 can then be notified of the user being in a discovered location. Location-based services can then be performed. In one embodiment, a location-based profile application can set the user's profile automatically when the user is at work to an “in the office” profile. An office profile may set the user volume mode to silent or vibrate-only. In one embodiment, a home profile may set the UE 101 to be unlocked while a non-home profile may set the UE 101 to a locked mode for security. In another embodiment, the location-based application may set the user settings or network settings.

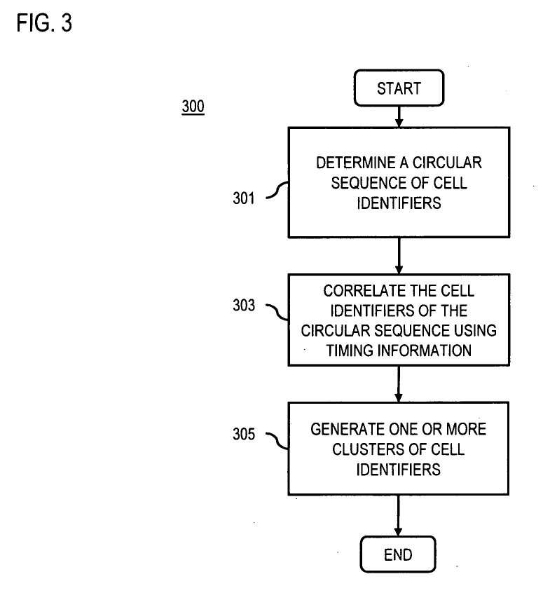

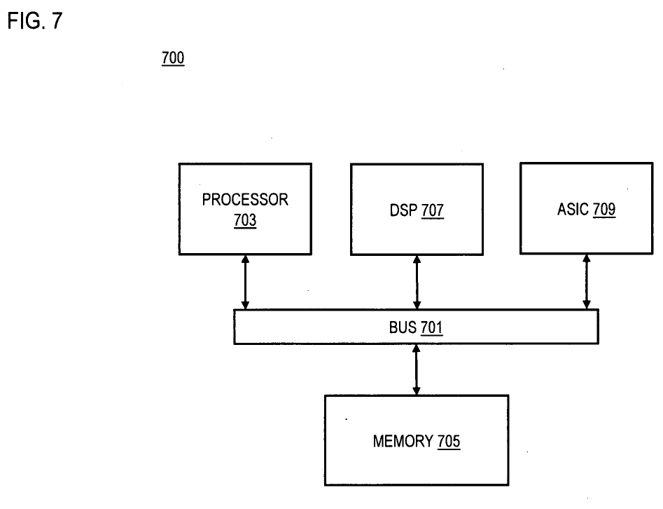

FIG. 3 is a flowchart of a process for discovering significant places using cell identifiers, according to one embodiment. In one embodiment, the runtime module 205 performs the process 300 and is implemented in, for instance, a chip set including a processor and a memory as shown FIG. 7. The runtime module 205 of a UE 101 (e.g., a mobile device) receives cell identifiers and timing information of when the cell identifier was observed from a location module 213 and stores the data in a cell database 209. The runtime module 205 can then process the stored data in the cell database 209. In one embodiment, the input format for analyzing cell-IDs is sequential. In this embodiment, a place is represented as a set of cell-IDs of geographically collocated or nearby cells. It is a set rather than a single cell-ID because cells are often deployed with overlapping to enhance connectivity robustness. Even stationary, a mobile phone may dynamically hand off to a different cell if the new cell is considered “better” than the current one. Thus, observed “raw” cell-IDs should be clustered before further analysis as to locations is completed.

In step 301, the runtime module 205 determines a circular sequence of cell identifiers associated with the UE 101. Each of the cell identifiers can have timing information according to when the mobile device has coverage by a corresponding cell. In one embodiment, the runtime module 205 determines if a cell identifier is within a sliding window. If the cell identifier is not within the sliding window, the runtime module 205 can append the cell identifier to the window. The runtime module 205 then determines whether the sliding window includes a circular subsequence of the cell identifiers. A circular subsequence is a sequence where the cell identifiers are sequenced in a circular fashion (e.g., “XABCBY” has a circular subsequence “BCB”). The circular sequence can have a predetermined cardinality. A cardinality of a sequence is the number of different symbols in it. Thus in a sequence of “XABBBCCAY,” “ABBBCCA” is a proper circular subsequence with cardinality of three. Once a circular subsequence is determined, the runtime module 205 can add the contents of the sliding window composing the circular subsequence to one of the clusters. In some embodiments, the window value's cardinality is set to prevent over-clustering. Thus, if the sliding window has a window value greater than the predetermined cardinality, the earliest cell identifier in the sliding window is removed. If the cell identifier has not previously been identified with a location, it is identified as a sole cluster and location.

At step 303, the runtime module 205 can process the cell identifiers of the circular sequence using timing information. In one embodiment, the runtime module 205 analyzes a circular subsequence for missing data. In this embodiment, cell identifiers are observed periodically with a frequency of f. In one embodiment, cell identifiers are observed every minute. If a portion of the circular subsequence has missing data, the sequence with the missing data is not considered as a candidate for becoming a cluster. In one embodiment, with extreme conservativeness, no missing data would be tolerated, and any event of missing data would cause the sliding window to be reset. In another embodiment, with extreme aggressiveness, the missing data would be ignored, and the sliding window would remain unchanged. In another embodiment, if there is evidence that one cell identifier and another cell identifier are adjacent, it is reasonable for the runtime module 205 to cluster them together, if other necessary conditions are met, even there is missing data between the cell identifiers. Evidence could be that one cell identifier is seen adjacent to the other without any missing data. In one embodiment, a list can be processed that would track the timestamps of the cell IDs to discover missing data, if the runtime module 205 sees two or more missing chunks of data, the cluster candidate may be dropped.

In another embodiment, the runtime module 205 determines whether the correlated cell identifiers are qualified cell identifiers to verify that the user is not traveling. If a cell is not qualified, a user driving in traffic may see multiple circular subsets (e.g., {A, B}, {B, C}, {C, D}, and {D, E}) as possible clusters. These may be grouped together as one location instead of multiple locations if the cell identifiers are not qualified. A cell identifier is qualified based on the number of times the cell identifier appears during either a time period or in a circular sequence. For example, a cell identifier can be qualified if the cell identifier is seen more than fifteen times during the course of a twenty hour period. In one embodiment, clustering is only allowed around qualified cell identifiers. In one embodiment, a cell identifier is qualified if the cell identifier is seen at least ten times in a twenty-four hour period. A function to determine if the cell identifier is qualified can be used on a cell identifier before being processed. In some embodiments, a service platform 103 can determine the qualification parameters of a cell identifier dynamically based on area code or time zone information.

At step 305, the runtime module 205 generates clusters of cell identifiers based on the cell identifier correlations. The clusters can be designated as significant places. A significant place can be a recurring place such as an office or a home, or it can be a nonrecurring place such as a vacation area or a business trip.

According to this approach, a UE 101 can determine significant places of a user. In this manner, the UE 101 is enabled to perform location-based functions beneficial to the user. For example, this allows a user change the user's profile to vibrate when the user is in a work area.

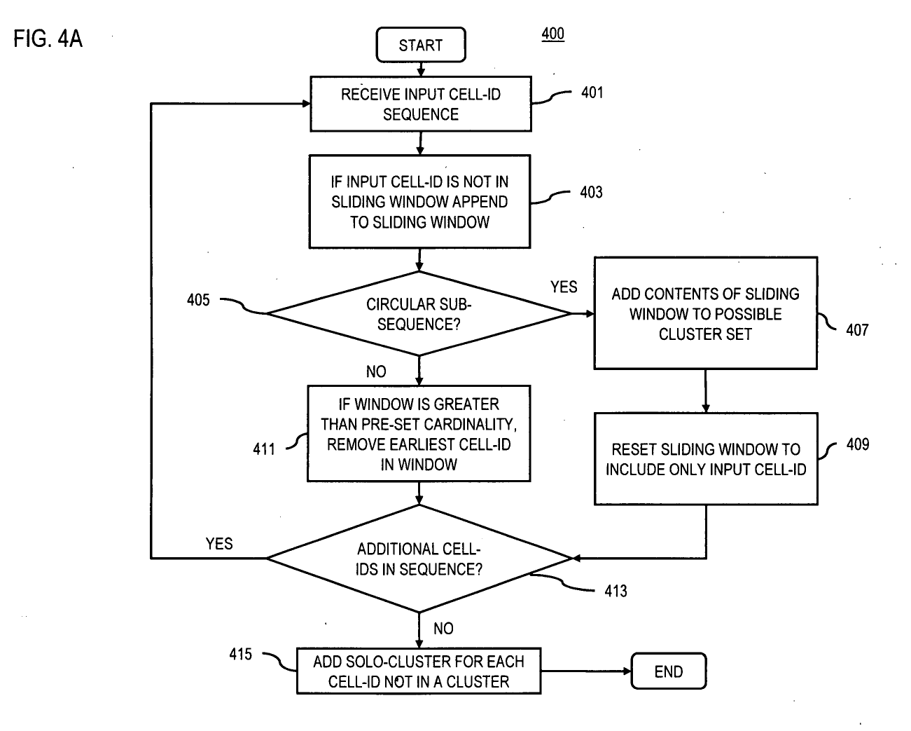

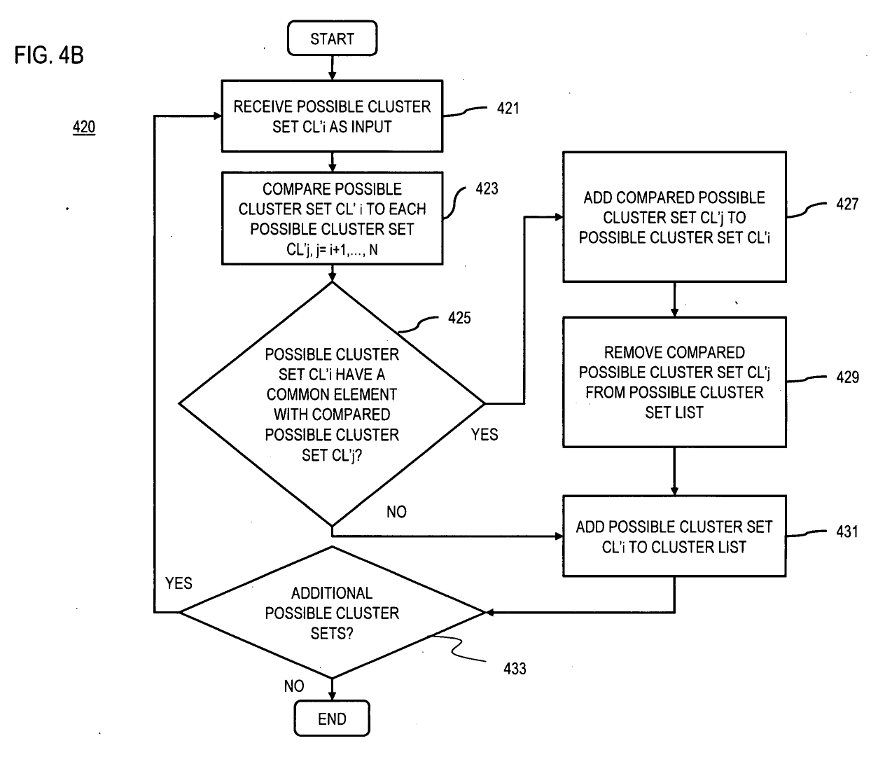

FIGS. 4A and 4B are flowcharts of processes for discovering significant places using cell identifiers, according to one embodiment. In one embodiment, the runtime module 205 performs the processes 400 and 420 and is implemented in, for instance, a chip set including a processor and a memory as shown FIG. 7. A discovery application 107n is activated by a user or UE 101 and can run in the background or foreground of the UE 101. The discovery application 107n receives an identifier from a cell via the location module 213 with a frequency of f (e.g., once every minute, once every ten seconds, etc.) while the application is running and can store the data in a cell database 209. The discovery application 107n can run in multiple modes, in one mode, the discovery application 107n gathers data. In another mode, the discovery application 107n analyzes the data.

At step 401, the discovery application 107n receives an input cell identifier sequence. The cell identifier, in one embodiment, is saved to a list of observed cell identifiers. The cell identifier is compared against a sliding window set w of cell identifiers. The sliding window w can have a cardinality threshold of S. A cardinality of a sliding window is the number of different symbols in it. At step 403, if the sliding window set does not contain the cell identifier, the cell identifier is appended to the sliding window set.

At step 405, the discovery application 107n determines if a circular subsequence is completed by the addition of the input cell identifier. For example, if a sliding window contains “AB” and the input cell identifier is “B” or “C” a circular subsequence is not completed, but if the input cell identifier is “A,” a circular subsequence is completed. If a circular subsequence is completed, at step 407, the contents of the sliding window are added to a possible cluster set CL′. Then, at step 409, the sliding window is reset to include only the input cell identifier. At step 405, if there is not a circular subsequence, the discovery application 107n determines if the sliding window set has a greater size than the pre-set cardinality threshold S. If the window is above the threshold, at step 411, the earliest cell identifier in the window is removed. Then, at step 413, the discovery application 107n determines if there are additional cell identifiers in the sequence. If or when there are additional cell identifiers in the sequence, the process begins with the new input cell identifier at step 401. At step 415, if there are no additional cell identifiers, the discovery application 107n adds any cell identifier that has been observed (but not yet clustered) to a solo cluster.

In one embodiment, once possible cluster sets CL′ are determined, the possible cluster sets CL′ can be processed to determine clusters CL. At step 421, a possible cluster set CL′ᵢ is received as input. At step 423, CL′ᵢ is compared to all of the possible cluster sets CL′ⱼ where j=i+1, . . . , N. Step 425 determines if the possible cluster set CL′ᵢ has a common element with possible cluster set CL′ⱼ. If there is a common element, at step 427, the new elements of the cluster set CL′ⱼ are added to the input possible cluster set CL′ᵢ. Then, at step 429, the cluster set CL′ⱼ with the common element is removed from the possible cluster set list. Once CL′ᵢ is compared to each possible cluster set, at step 431, possible cluster set CL′ᵢ is added to the cluster list CL and removed from the possible cluster set list. At step 433, the process determines if there are additional possible cluster sets available. If or when there are additional possible cluster sets available, the process begins at step 421 with a new possible cluster set.

With the above approach, a UE 101 can use location-based services by determining the significant places of a user in a cost-efficient manner. Thus, the UE 101 is able to determine the significant places on a preexisting UE 101 without hardware modifications by downloading a discovery application 107n. Additionally, because the UE 101 is able to determine the significant places without additional resources, the information is kept secure and private. Furthermore, it is contemplated that the described processes can be performed on the UE 101 without connectivity to a public data network, such as the Internet. However, with Internet connectivity, advertisement services can be deployed, whereby UE 101 can receive ads based on location of the UE 101.

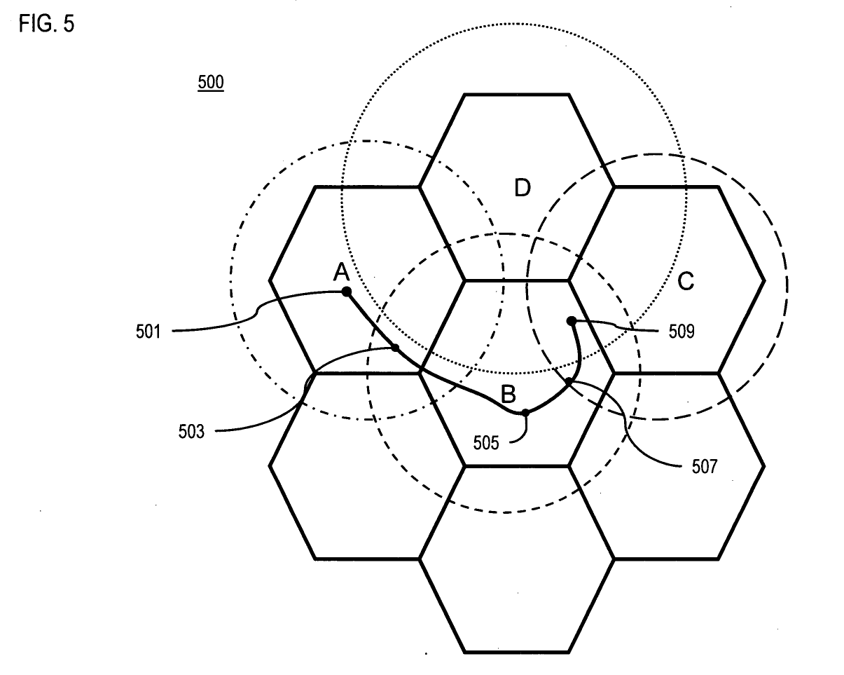

FIG. 5 is a diagram of coverage areas of cell sites, according to one embodiment. The diagram 500 can be used in conjunction with Table 1 below to exemplify the processes of FIG. 4.

TABLE 1

| | Cell ID sequence | w | CL′ | CL |
|---|---|---|---|---|
| 1 | \check{ }AAABBCCCBDCD | [ ] | { } | { } |
| 2 | \check{A}AABBCCCBDCD | [A] | { } | { } |
| 3 | AAA\check{B}BCCCBDCD | [AB] | { } | { } |
| 4 | AAABB\check{C}CCBDCD | [BC] | { } | { } |
| 5 | AAABBCCC\check{B}DCD | [B] | {{B,C}} | { } |
| 6 | AAABBCCCB\check{D}CD | [BD] | {{B,C}} | { } |
| 7 | AAABBCCCBD\check{C}D | [DC] | {{B,C}} | { } |
| 8 | AAABBCCCBDC\check{D} | [D] | {{B,C}, {C,D}} | { } |
| 9 | AAABBCCCBDCD\check{ } | [ ] | { } | {{B,C,D}, {A}} |

In this embodiment, input cell identifiers (e.g., cell-IDs) are lined up in time-ascending order. The cardinality threshold S=2. The check mark (^{✓}) indicates the current cell identifier being looked at. Objects w (sliding window), CL′ (possible cluster set) and CL (cluster) are shown as the algorithm progresses. Eventually, in this embodiment, B, C and D are clustered together; A forms a solo-cluster.

In one embodiment, a user moves from point 501 through a route that includes points 503, 505, and 507, and ends at point 509. The discovery application 107n follows tracks the movements as shown in Table 1. The discovery application 107n is able to “see” a cell if the UE 101 the discovery application 107n is running on is connected to the cell when taking an observation. At line 1, the sliding window w as well as possible cluster set CL′ and cluster set CL are empty. At line 2, the discovery application 107n sees cell A and cell A is added to w. At line 3, a few iterations later, at point 503, the discovery application 107n sees cell B and adds B to the sliding window. The user goes through point 505 and travels to point 507. At line 4, the discovery application 107 is able to see cell C. At this point, C is added to the window w. Because the cardinality is 2, cell A is removed from w and added to a temporary list of clusters. At line 5, the discovery application 107n sees cell B again. Next, the discovery application 107n finds a circular subset of “BCB.” Thus, the discovery application 107n creates a possible cluster set CL′ and places cells B and C in the set. The discovery application 107n also resets the window to the inputted cell identifier, B.

The user then completes the user's journey to point 509. At line 6, the discovery application 107n sees cell D. D is appended to w. At line 7, the discovery application sees cell C, cell C is appended to the sliding window and because the cardinality of the window is 2, B is removed. B is not placed in a temporary list of clusters because B is an element of one of the CL′ sets. At line 8, the discovery application 107n sees cell D again, completing another circular subset “DCD.” Thus, the window elements are added as a possible cluster CL′. At line 9, there are no more cell IDs in the sequence. An algorithm runs to determine which possible cluster sets are clusters. In the end, B, C and D are clustered together and A forms a solo-cluster.

The above arrangement and processes, according to certain embodiment, advantageously permits deployment of location-based services to mobile devices without requiring costly circuitry, such as a GPS components. Moreover, locations can be determined using an efficient discovery scheme, thereby saving precious power on the mobile devices.

The processes described herein for discovering significant places may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

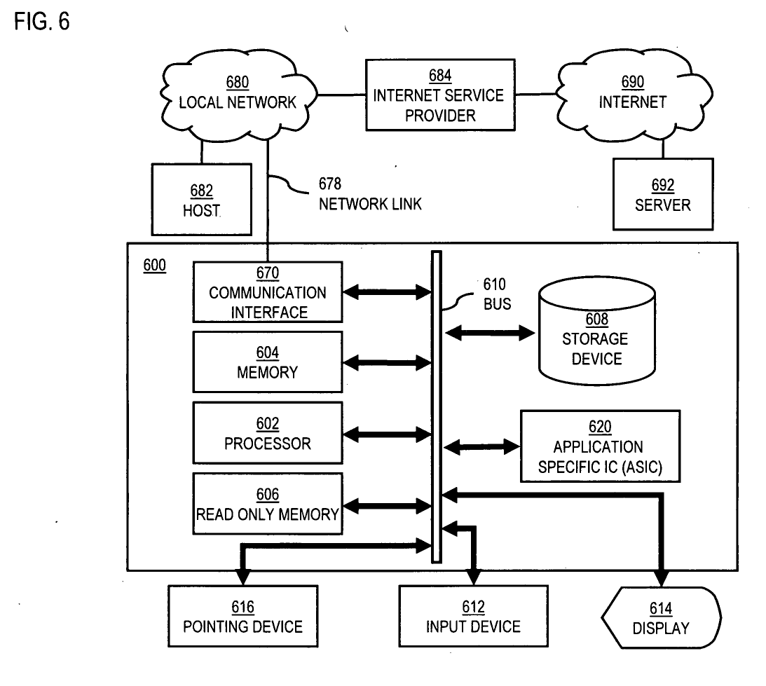

FIG. 6 illustrates a computer system 600 upon which an embodiment of the invention may be implemented. Computer system 600 is programmed (e.g., via computer program code or instructions) to discover significant places as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to discovering significant places. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for discovering significant places. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for discovering significant places, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for facilitating services to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 7 illustrates a chip set 700 upon which an embodiment of the invention may be implemented. Chip set 700 is programmed to discovering significant places as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to discover significant places. The memory 705 also stores the data associated with or generated by the execution of the inventive steps.

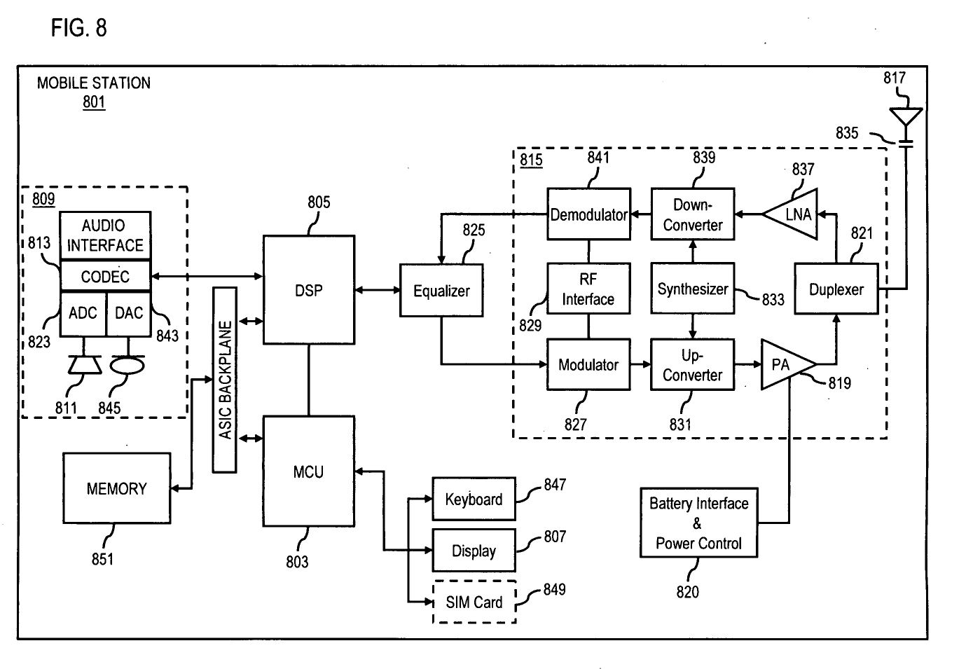

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803-which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to discover significant places. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a circular sequence of cell identifiers associated a mobile device, each of the cell identifiers having timing information according to when the mobile device has coverage by a corresponding one of a plurality of cells, wherein the circular sequence has a predetermined cardinality;
correlating the cell identifiers of the circular sequence using the timing information; and
generating one or more clusters of cell identifiers based on the correlated cell identifiers, wherein the one or more clusters are designated as one or more significant places.

2. A method of claim 1, further comprising:
determining whether the correlated cell identifiers are qualified cell identifiers based on a predetermined number of times each of the correlated cell identifiers appear in the circular sequence.

3. A method of claim 2, wherein the step of determining the circular sequence includes:
determining whether one of the cell identifiers is within a sliding window;
appending the one cell identifier if the one cell identifier is not within the sliding window;
determining whether the sliding window includes a circular subsequence of the cell identifiers; and
adding contents of the sliding window to one of the clusters if the sliding window is determined to include the circular subsequence.

4. A method of claim 3, wherein the step of determining the circular sequence includes:
determining whether the sliding window has a window value greater than the predetermined cardinality; and
removing an earliest one of the cell identifiers in the sliding window.

5. A method of claim 1, further comprising:
determining whether a portion of the circular sequence is missing a plurality of cell identifiers; and
eliminating the portion as a candidate for the one or more clusters.

6. A method of claim 1, wherein the one or more significant places includes a non-recurring place.

7. A method of claim 1, wherein the method is performed on the mobile device that is without connectivity to a public data network.

8. An apparatus comprising:
at least one processor; and
at least one memory including computer program code,
the at least one memory and the computer program code configured to, with the at least one processor, cause the apparatus to perform at least the following,
determine a circular sequence of cell identifiers associated a mobile device, each of the cell identifiers having timing information according to when the mobile device has coverage by a corresponding one of a plurality of cells, wherein the circular sequence has a predetermined cardinality,
correlate the cell identifiers of the circular sequence using the timing information, and
generate one or more clusters of cell identifiers based on the correlated cell identifiers, wherein the one or more clusters are designated as one or more significant places.

9. An apparatus of claim 8, wherein the apparatus is further caused to:
determine whether the correlated cell identifiers are qualified cell identifiers based on a predetermined number of times each of the correlated cell identifiers appear in the circular sequence.

10. An apparatus of claim 9, wherein the apparatus is further caused to at the determine the circular sequence step:
determine whether one of the cell identifiers is within a sliding window;
append the one cell identifier if the one cell identifier is not within the sliding window;
determine whether the sliding window includes a circular subsequence of the cell identifiers; and
add contents of the sliding window to one of the clusters if the sliding window is determined to include the circular subsequence.

11. An apparatus of claim 10, wherein the apparatus is further caused to at the determine the circular sequence step:
determine whether the sliding window has a window value greater than the predetermined cardinality; and
remove an earliest one of the cell identifiers in the sliding window.

12. An apparatus of claim 8, wherein the apparatus is further caused to:
determine whether a portion of the circular sequence is missing a plurality of cell identifiers; and
eliminate the portion as a candidate for the one or more clusters.

13. An apparatus of claim 8, wherein the one or more significant places includes a non-recurring place.

14. An apparatus of claim 8, wherein the mobile device is a mobile phone, the apparatus further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

15. A computer-readable storage medium carrying one or more sequences of one or more instructions which, when executed by one or more processors, cause an apparatus to perform at least the following:
determine a circular sequence of cell identifiers associated a mobile device, each of the cell identifiers having timing information according to when the mobile device has coverage by a corresponding one of a plurality of cells, wherein the circular sequence has a predetermined cardinality;
correlate the cell identifiers of the circular sequence using the timing information; and
generate one or more clusters of cell identifiers based on the correlated cell identifiers, wherein the one or more clusters are designated as one or more significant places.

16. A computer-readable storage medium of claim 15, wherein the apparatus is further caused to:
determine whether the correlated cell identifiers are qualified cell identifiers based on a predetermined number of times each of the correlated cell identifiers appear in the circular sequence.

17. A computer-readable storage medium of claim 16, wherein the apparatus is further caused to at the determine the circular sequence step:
determine whether one of the cell identifiers is within a sliding window;
append the one cell identifier if the one cell identifier is not within the sliding window;
determine whether the sliding window includes a circular subsequence of the cell identifiers; and
add contents of the sliding window to one of the clusters if the sliding window is determined to include the circular subsequence.

18. A computer-readable storage medium of claim 17, wherein the apparatus is further caused to at the determine the circular sequence step:
determine whether the sliding window has a window value greater than the predetermined cardinality; and
remove an earliest one of the cell identifiers in the sliding window.

19. A computer-readable storage medium of claim 15, wherein the apparatus is further caused to:
determine whether a portion of the circular sequence is missing a plurality of cell identifiers; and
eliminate the portion as a candidate for the one or more clusters.

20. A computer-readable storage medium of claim 15, wherein the one or more significant places includes a non-recurring place.
